(19) United States
(12) Patent Application Publication
(10) Pub. No.: US 2014/0291368 A1
(43) Pub. Date: Oct. 2, 2014

(54) Reward System And Decorative Bike Frame Insert

(71) Applicant: Zike, LLC, Greenville, SC (US)

(72) Inventor: Nathan A. Scolari, Greenville, SC (US)

(73) Assignee: Zike, LLC, Greenville, SC (US)

(21) Appl. No.: 14/190,685

(22) Filed: Feb. 26, 2014

Related U.S. Application Data
(63) Continuation-in-part of application No. 13/538,484, filed on Jun. 29, 2012.
(60) Provisional application No. 61/785,484, filed on Mar. 14, 2013.

(51) Int. Cl. B62J 11/00; G06Q 30/02

(52) U.S. Cl. CPC B62J 11/00; G06Q 30/0207
USPC 224/418

(57) ABSTRACT

A system for rewarding a rider for achieving milestones having an insert attached to a top support member, front support member and rear support member of a frame of a non-motorized personal vehicle; a removable section removably attached to said insert so that when rider achieves a milestone, the rider can receive a reward in the form of a removable section from the vendor and attach the reward to the insert; and reward components taken from the group consisting of printed material, beads, lights, LED lights, streamers, ornamentation, colors, logos, pinwheels and pockets.

### FIELD OF THE INVENTION

This invention is directed to a system for rewarding riders of personal mobility devices, and more specifically, awarding prizes for distance traveled on non-power personal mobility devices such as scooters and bicycles.

### BACKGROUND

There is a continued growing interest in physical exercise to stay in good physical shape. Bicycles, for example, have been around for centuries as a mode of transportation and have grown to popular and useful means for physical exercise. Accessories for bicycles have also been developed to increase the usefulness of bicycles. For example, United States Patent Publication 2010/0012696 is directed to a briefcase/saddleback which is placed on a bike frame to straddle the top tube and be secured to the down tube and seat tube. Likewise, U.S. Pat. No. 5,031,807 is a Bicycle Brief Case which also straddles the top tube and secures to the down tube and seat tube. U.S. Pat. No. 603,018 is a Luggage Carrier for a bicycle connected to the top tube and handlebar stem receiver. U.S. Pat. No. 1,485,067 is a Balanced Bicycle Bag that straddles the top tube and connects to the seat and down tube. U.S. Pat. No. 4,720,027 is a Bicycle Cross-Bar Bag that straddles the top tube and connecter to the seat and down tube.

These inventions are designed to increase the utility of the bicycle, but not necessarily the aesthetic value. Further, these inventions have no relation to any reward system to increase or promote the use of a bicycle for physical exercise.

Additionally, accessories include U.S. Pat. No. 5,249,721 which is an Interframe Article Carrier that connects to the top tube, down tube, and seat tube. U.S. Pat. No. 6,253,979 is a Suspension Bicycle Bag which connects to the top, seat, and down tube.

As technology progresses, additional accessories have been developed such as U.S. Pat. Nos. 360,269 and 587,010 which are directed to Analog Cyclometers. U.S. Pat. No. 5,847,641 is a digital bicycle computer with wireless transmission between the components. U.S. Pat. No. 5,450,325 is a Route Directions Display System for bicycles.

While these accessories include functionality such as route information, cyclometer information, route waypoints and computerized display and digital operation, none of these are directed to a reward system for promoting the use of a non-motorized personal mobility device.

Further, for children, there is an increased design to personalize such objects as bicycles and scooters. Custom license plates, streamers, stickers, colored seats, and tires, and the like are all available for purchase for such uses. Typically, however, these personalization items are purchased independently of any achievements unless individually imposed upon the child.

Therefore, it is an object of this invention to provide for a reward system which provides personalization and decorative items for non-motorized personal mobility devices with specific achievement levels.

It is another object of the invention to provide for a non-motorized personal mobility device insert which can be added to an existing frame, such as a bicycle, which allows fitting to various frame configurations.

It is another object of the invention to promote physical fitness as well as enticing riders to patronize establishments which provide rewards.

### BRIEF DESCRIPTION OF THE DRAWINGS

The invention is further described in reference to the following drawings which are incorporated by reference:

FIGS. 1A and 1B are elevated views of the aspects of the invention;

FIG. 2 is a flowchart of the invention;

FIG. 3 is a schematic of the invention;

FIGS. 4A and 4B are elevated views of the invention;

FIGS. 5A and 5B are elevated views of the invention; and,

FIGS. 6A and 6B are elevated views of the invention.

### SUMMARY OF THE INVENTION

The construction designed to carry out the invention will hereinafter be described, together with other features thereof. The invention will be more readily understood from a reading of the following specification and by reference to the accompanying drawings. The objects of the invention are accomplished by providing a system for rewarding a rider for achieving milestones comprising the following: a bike computer having a removable memory for recording travel information; a server for receiving travel information from the bike computer through an electronic communications means; a vendor computer readable medium for accessing travel information associated with the rider from the server; and, a reward item delivered to the rider from the vendor when the rider achieves a certain milestone in travel distance. The reward item can be a flag insert having a printed area and a storage pocket.

### DESCRIPTION OF THE INVENTION

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein. With reference to the drawings, the invention will now be described in more detail.

The detailed description that follows may be presented in terms of program procedures executed on a computer or network of computers so that when executed, provide tangible results. These procedural descriptions are representations used by those skilled in the art to most effectively convey the substance of their work to others skilled in the art. These procedures herein described are generally a self-consistent sequence of steps leading to a desired result and the manipulation of data and their physical objects from one state to another. These steps require physical manipulations of physical quantities such as electrical or magnetic media capable of being stored, transferred, combined, compared, or otherwise manipulated.

Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”), computer program products and computer readable instructions according to the invention. It will be understood that each block of a flowchart illustration can be implemented by a set of computer readable instructions or code that can be executed by a processor. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks.

Computer readable instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

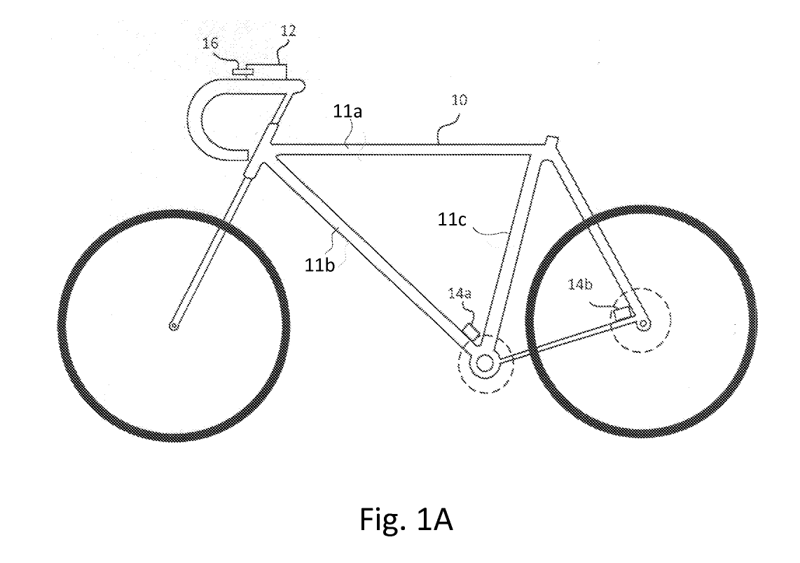

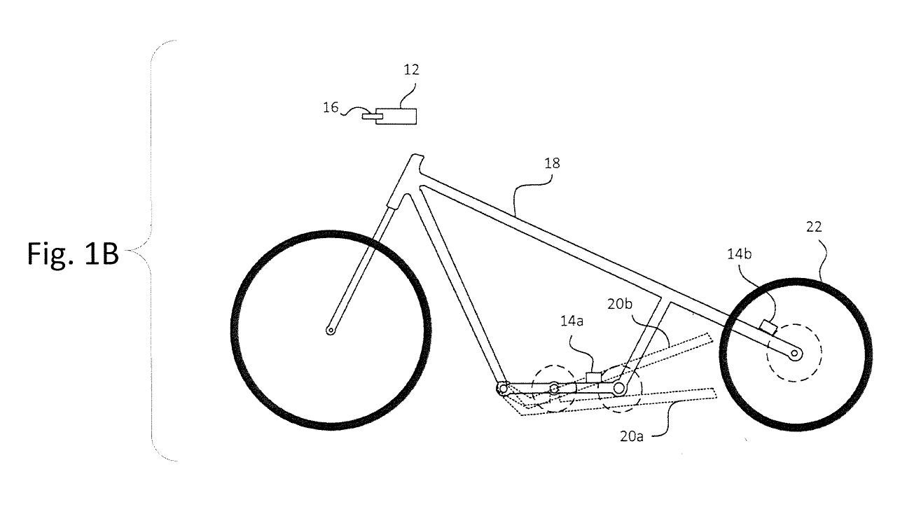

Referring now to FIG. 1A, a bike frame 10 is shown having a bike computer 12. The bike computer can record information about the rider including the distance travelled by the rider. Sensors 14a or 14b or both can be included to measure rotations of the pedals, sprockets, spokes, and the like to convert rotations into distance travelled. In one embodiment, the sensors can be an accelerometer connected to the rider. The sensor can transmit its information to the bike computer using a wired or wireless connection. A portable memory storage unit 16 such as a USB device can be removably attached to the bike computer so that the travel information can be transferred to another computer readable medium. In one embodiment, the sensor can include a portable memory device 16 such as with the cyclometer worn by the rider.

In one embodiment shown in FIG. 1B, a seat-less bicycle 18 includes the bike computer (handle bars not shown), portable memory device, and sensors. Pedals 20a and 20b are arranged to simulate a stair stepping action and to transfer power generated form the rider to sprockets 22 and ultimately to the rear wheel 24. As with the traditional bicycle frame, chains are used to transfer power from the sprockets to the rear wheel.

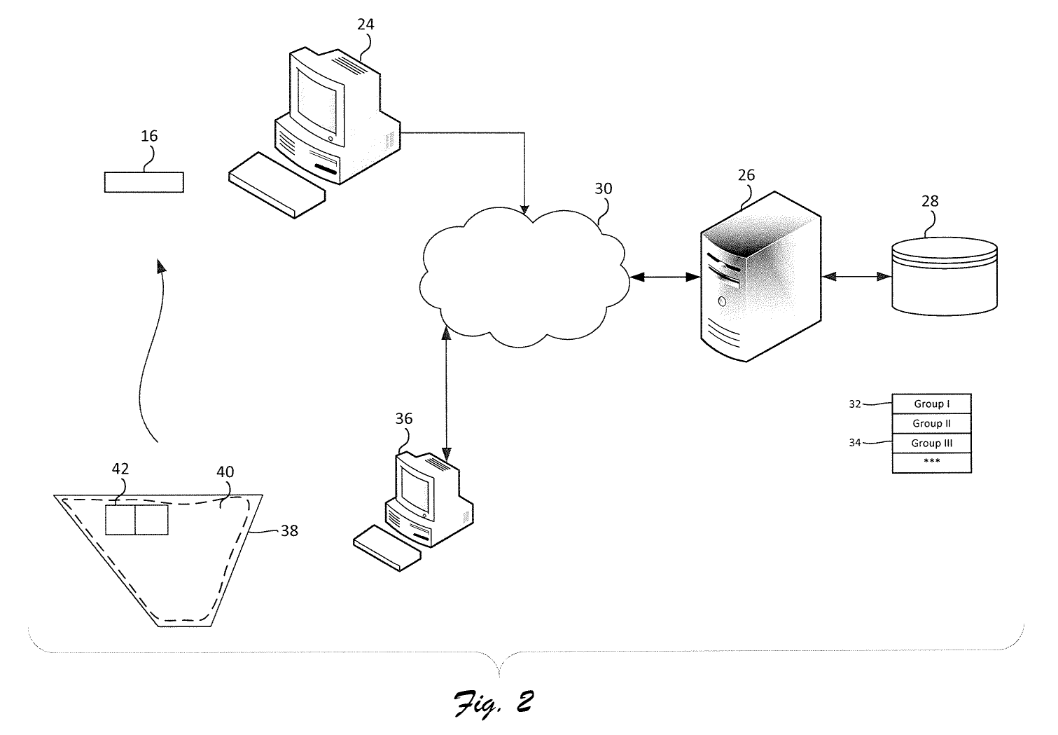

Referring to FIG. 2, a portable memory device 16 can be used to transfer travel information to a computer 24. The travel information can then be uploaded and stored on a computer 24. The travel information can also be transmitted to a central computer 26 having a database 28 through a global communications network 30 (such as the Internet) or other communications means. The travel information can be stored in a database 28 and associated with rider identification information. Rider identification information can have a number of customizable fields including: name, password, age, address, reward item selection, travel distances for triggering rewards, travel time for triggering rewards, preferred vendors of rewards, and the like. For example, the rider identification information can have milestones equating to distances travelled so that if the rider travels a certain distance (either predetermined or set through customization), the rider can select a reward from a Group I shown as 32. If the rider achieves the next milestone, the rider can select a reward from Group II shown as 34.

Once travel information is available at a central computer 26, the travel information can be transmitted or accessed by a vendor computer 36. The rider can be informed of participating vendors as well as notified when the rider hits a milestone and can be instructed to visit a particular vendor to obtain the reward. The computer readable instructions at the vendor computer provide the vendor with information concerning which reward the rider is eligible to receive. When the rider visits the vendor, the vendor can access the rider information and provide to the rider the appropriate reward. The vendor can review the rider information and also inform the rider what the next milestone is.

By accessing rider information for all the riders that have designated the vendor a preferred vendor, the vendor can review historical information such as number of riders participating, frequency of milestones being achieved, number of rewards obtained, and number of rewards obtained from the vendor. Such information is valuable to the vendor for marketing and market analysis. Further, the vendor can anticipate the inventory of rewards to keep in stock.

One such reward is a flag insert 38 which can have printing 40 on the side of the flag. A pocket 42 can also be attached to the flag for storing items when the rider is riding the bike. In one embodiment, the pocket includes an insulated pocket for holding items such as ice to keep a liquid cool. The pocket can be sealable to help secure items into the pocket. The insulated pocket can be sealable to prevent melted ice from sloshing out of the pocket while the rider is riding.

The flag insert can be taken from the vendor and installed on the rider's bike. The printed portion allows for current desirable items to be associated with the flag insert. For example, the current popular superheroes, toys, movies, athletic players, athletic teams, and the like.

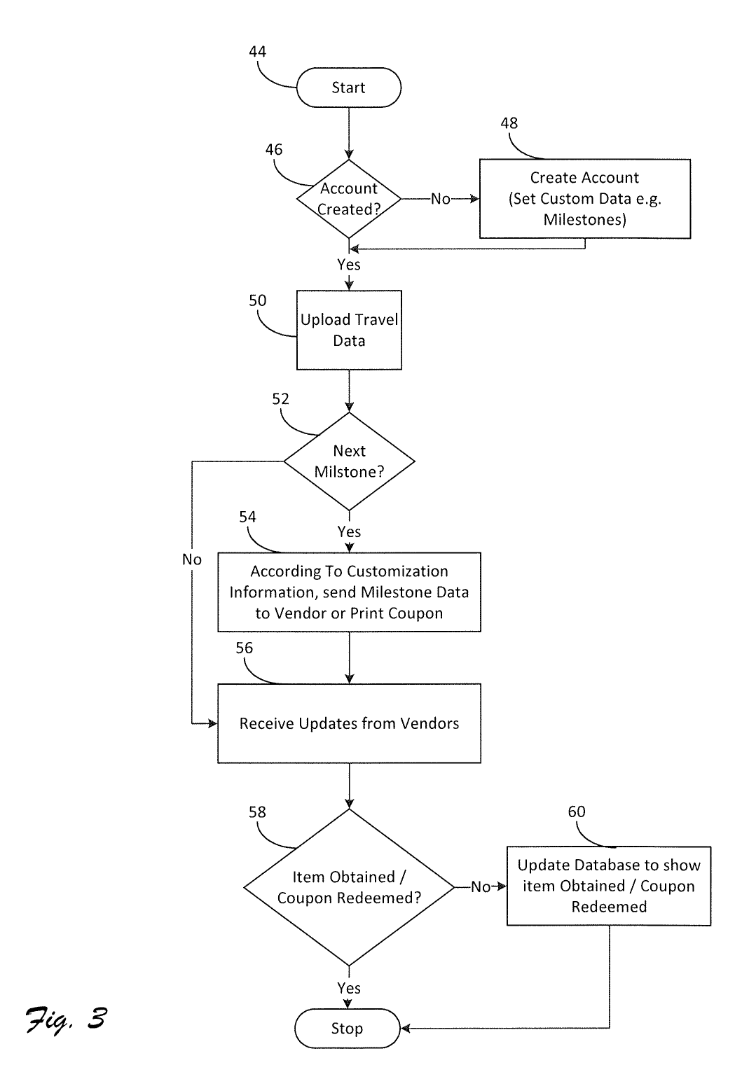

Referring to FIG. 3, the process is described in further detail. The process starts at 44. The computer readable instructions for the rider and the server can include these steps. A determination if a rider account has been created is made at 46. If no account has been created, the rider can create an account at 48 and rider information such as: name, password, age, address, reward item selection, travel distances for triggering rewards, preferred vendors of rewards, and the like. Travel information can be received (uploaded) at 50. A determination if the next milestone was achieved is made at 52 and if so, the milestone information can be accessible by a vendor as 54. In one embodiment, the computer readable instruction can provide (e.g., print) a coupon for the rider that can be taken to participating vendors eliminating the need for vendors to have access to the central computer.

When the rider obtains the rider's reward, the vendor can review the rider information to see if the reward has been obtained at 56. Therefore, if the rider attempts to obtain the same reward at 58, the rider will not be able to do so. Otherwise, the vendor can update the rider information at 60 and the rider is free to achieve the next milestone.

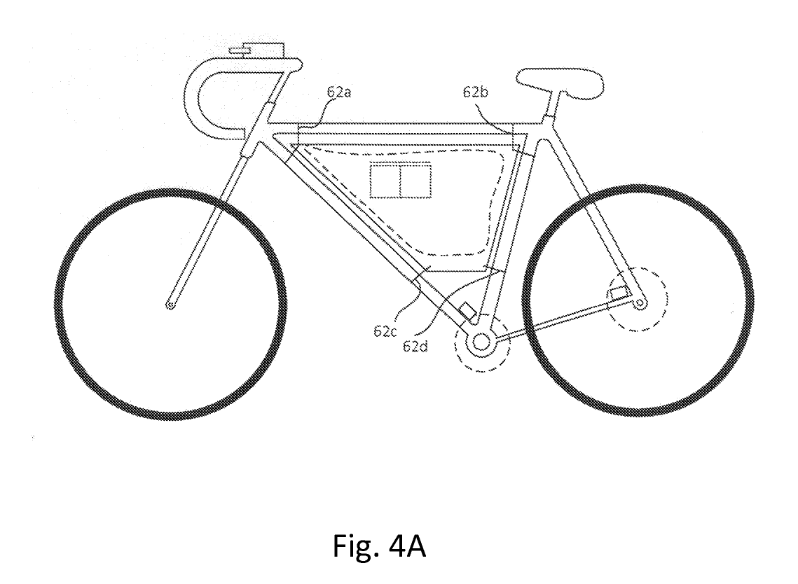

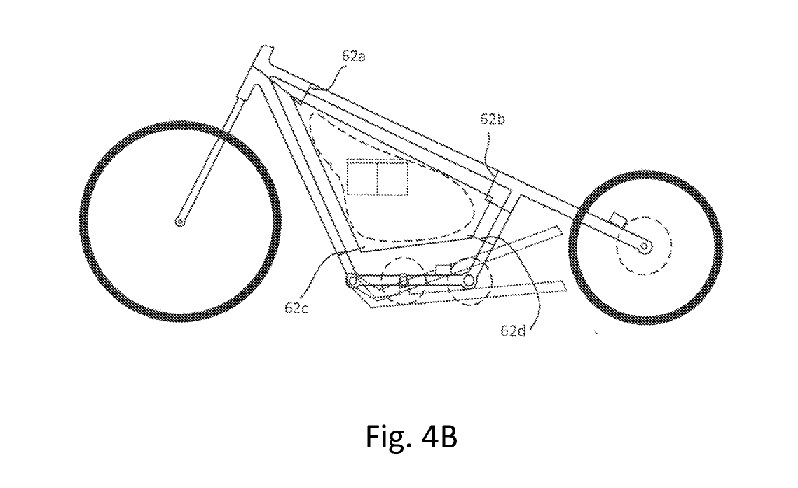

Referring to FIGS. 4A and 4B, the flag insert is shown installed on a bike. Connections 62a through 62d are used to attach the flag insert to the frame. In one embodiment, connection 62a is at the intersection of top support member 11a of the frame and the front support member 11b of the frame. Connection 62b is at the intersection of the top support member of the frame and the rear support member 11c of the frame. Connection 62c is at the lower end of the front support member and connection 62d is at the lower end of the rear support member.

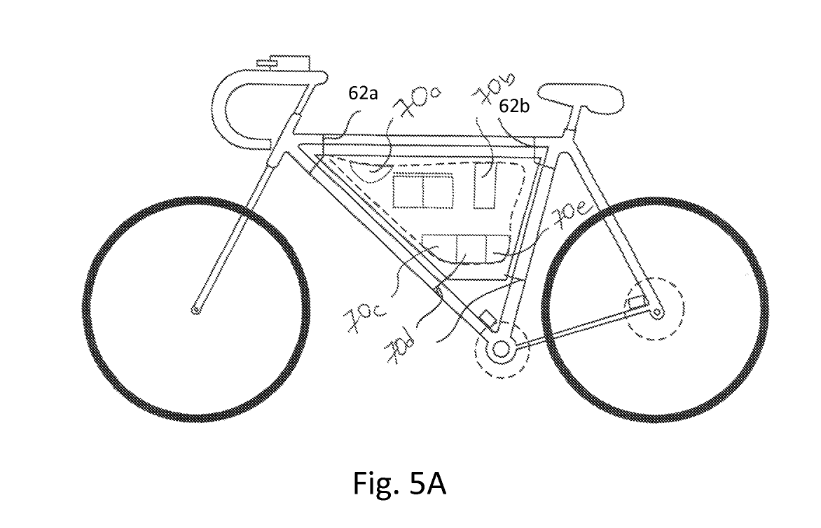

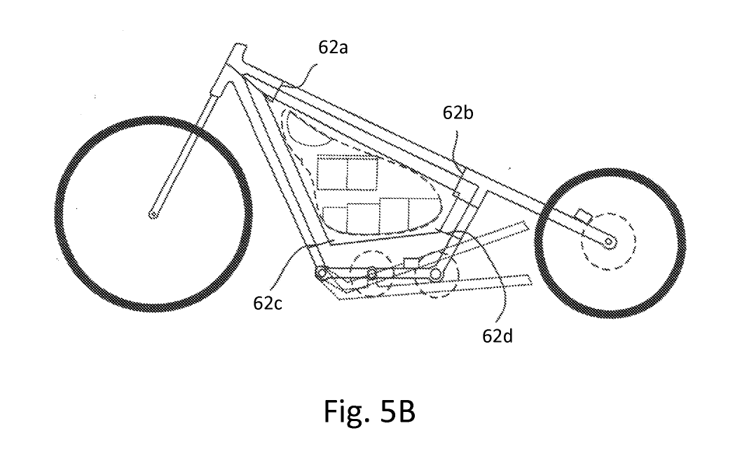

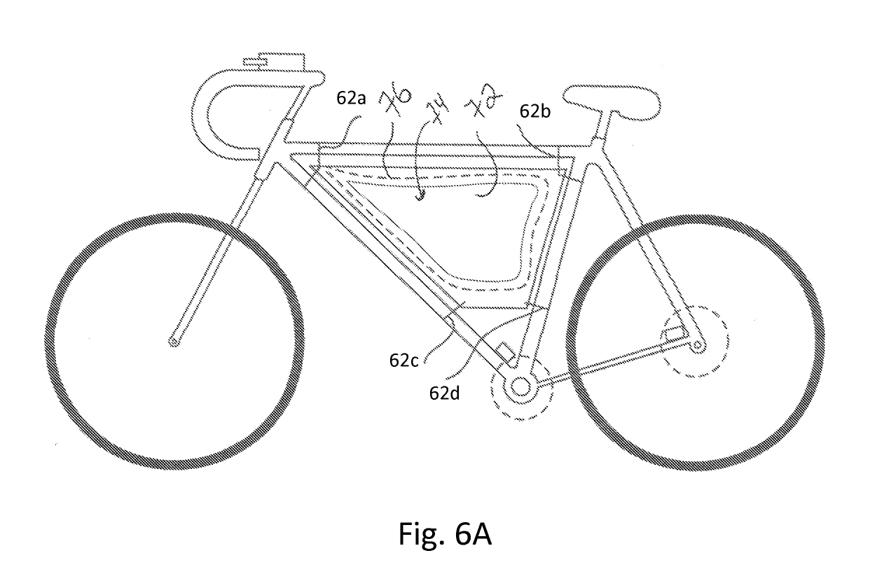

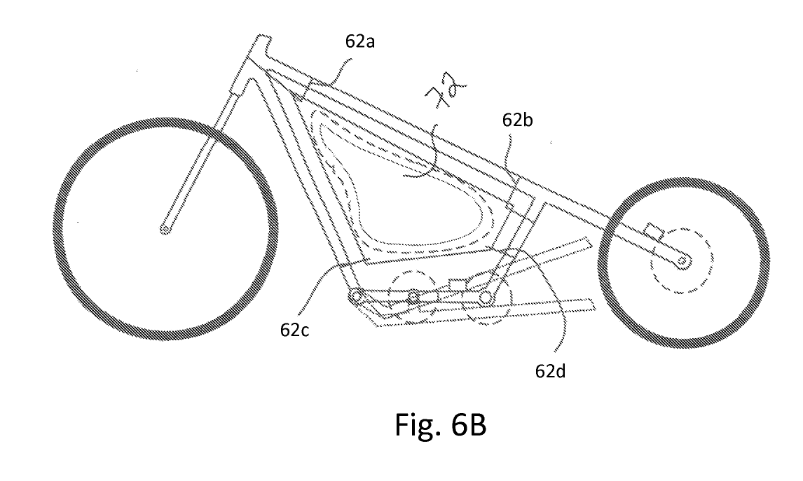

The connections are removably attached allowing the rider to remove and replace the flag insert with a different flag insert. Referring to FIGS. 5A and 5B, various embodiments of the insert as shown with various pockets 70a through 70e that can be included in the insert and shaped for specific utility such as for cellular phones, smart phones, iPhones, water bottles, wallets, keys, loose change, papers, credit cards, licenses, insurance cards, and other personal items. The pockets can be opened or sealable to contain the contents. The pockets can include insulation so as to keep liquids and other items hot or cool. Ice or ice packs or other coolants can be placed in the pockets as well. Referring to FIGS. 6A and 6B, the insert 72 can substantially occupy the space defined in the frame. Space 74 included in the insert can have a removable section 76 that can include printed material or content, beads, lights, LED lights, streamers, ornamentation, colors, logos, pinwheels and the like. The removable section allows for multiple additional materials to be attached to the insert so that the insert can be customized. For example, the insert and additional material can be attached to each other using a hook and loop fastener. These additional materials can be attached to the insert or removably attached to the insert. The additional material that is included with the insert can be determined based upon the reward achieved by the rider.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for rewarding a rider of a non-motorized personal vehicle having a frame and an internal area defined by said frame when achieving milestones comprising:
a rider computer system for recording travel distances of the rider and carried by the non-motorized personal vehicle;
a server in electronic communications with said rider computer system for receiving travel distances;
a vendor computer system in electronic communications with said server having pre-determined milestones associated with reward groups wherein each reward group represents specific removable sections;
an insert attached to said frame that substantially occupies said internal area; and,
a removable section attached to said insert having components taken from the group consisting of: printed material, beads, lights, streamers, ornamentation, colors, logos and pinwheels so that when rider achieves a milestone, the rider can receive a removable section from the vendor and attach the removable section to the insert.

2. The system of claim 1 wherein said insert includes a plurality of pockets.

3. The system of claim 2 including an insulated pocket.

4. The system of claim 2 including a sealable pocket.

5. The system of claim 1 wherein said streamers are disposed rearward of the insert so said streamers extend past the rear edge of said insert.

6. The system of claim 1 wherein said vendor computer system tracks the removable sections awarded to the rider so that rider does not receive duplicate removable sections.

7. The system of claim 1 wherein said rider is provided a coupon representing a milestone and said rider can exchange said coupon for a removable section.

8. The system of claim 1 wherein said insert is attached to said frame at the intersection of a front support member and the top support member, at the intersection of the top support member and the rear support member, at the lower end of the front support member and the lower end of the rear support member.

9. The system of claim 8 wherein the insert is removably attached to said frame.

10. The system of claim 1 including a plurality of pockets defined in said removable section.

11. The system of claim 1 wherein said removable section is attached to said insert through a hook and loop fastener configuration.

12. A reward provided to a rider of a non-motorized personal vehicle based upon milestones determined by a rider computer system that records travel distances, a server in electronic communications with said rider computer system for receiving travel distances, a vendor computer system in electronic communications with said server having pre-determined milestones associated with reward groups wherein each reward group includes specific rewards comprising:
an insert attached to the frame of said non-motorized personal vehicle having a space for receiving a removable section; and,
a removable section removably attached to said insert so that when rider achieves a milestone, the rider can receive a reward from a designated vendor in the form of a removable section and attach the reward to the insert.

13. The system of claim 12 including a plurality of pockets defined in said insert.

14. The system of claim 12 including an insulated pocket in said insert.

15. The system of claim 12 wherein said removable section includes components taken from the group consisting of printed material, beads, lights, streamers, ornamentation, colors, logos, pinwheels and pockets.

15. The system of claim 15 including an insulated pocket for holding a coolant included in said removable section.

16. A reward for use with a reward system for a rider of a non-motorized personal vehicle based upon milestones determined by a rider computer system that records travel distances, a server in electronic communications with said rider computer system for receiving travel distances or riding times, a vendor computer system in electronic communications with said server having pre-determined milestones associated with reward groups wherein each reward group includes specific rewards in the form of a removable section comprising:
an insert attached to a top support member, front support member and rear support member of a frame of a non-motorized personal vehicle;
said removable section removably attached to said insert so that when the rider achieves a milestone, the rider can receive a reward in the form of a removable section from the vendor and attach the reward to the insert; and,
reward components taken from the group consisting of printed material, beads, lights, streamers, ornamentation, colors, logos, pinwheels and pockets included with said removable section.

17. The system of claim 16 including an insulated pocket for receiving a coolant in said insert.

18. The system of claim 16 including an insulated pocket for receiving a coolant in said removable section.

19. The system of claim 18 wherein each reward component is associated with a reward group.

20. The system of claim 19 wherein each reward group is associated with a travel distance.
